(19) United States
(12) Patent Application Publication
(10) Pub. No.: US 2007/0275621 A1
(43) Pub. Date: Nov. 29, 2007

(54) NON-SLIP ROOFING UNDERLAYMENT AND METHOD FOR MANUFACTURING SAME

(76) Inventors: Dale Bennett, Benton, LA (US); Shawn Sharpe, Homer, LA (US); Frederick Spigener, Athens, LA (US)

Correspondence Address: Maldjian & Fallon LLC;Third Floor, 365 Broad Street, Red Bank, NJ, 07701, US

(21) Appl. No.: 11/752,703

(22) Filed: May 23, 2007

Related U.S. Application Data
(60) Provisional application No. 60/803,294, filed on May 26, 2006.

(51) Int. Cl. B32B 5/26; B32B 27/12

(52) U.S. Cl. 442/268; 442/277; 442/281; 156/244.27

(57) ABSTRACT

Embodiments of the present invention generally relate to a non-slip roofing underlayment made using an extrusion lamination process with a desirable minimum substrate-to-substrate static coefficient of friction of at least 0.400, made using an extrusion lamination process. In one embodiment, a roofing underlayment is manufactured from the steps comprising providing a first layer of a woven thermoplastic material, extruding a second layer of thermoplastic material on the first layer, at a temperature between about 470 degrees and about 600 degrees Fahrenheit, and laminating a third layer of non-woven thermoplastic material on the second layer through a nip at a pressure between about 50 pounds per square inch and about 90 pounds per square inch.

### CROSS-REFERENCE TO RELATED APPLICATIONS

This application claims the benefit of U.S. Provisional Application Ser. No. 60/803,294, entitled “Non-Slip Roofing Underlayment and Method,” filed May 26, 2006, the disclosure of which is incorporated herein by reference in its entirety.

### BACKGROUND OF THE INVENTION

1. Field of the Invention

Embodiments of the present invention generally relate to a roofing underlayment. More specifically, embodiments of the present invention relate to a non-slip roofing underlayment for use in roofing construction, and a method of manufacturing the same.

2. Description of the Related Art

Roofing structures typically comprise multiple layers of materials applied to the roof support structure. These layers may include a roofing underlayment affixed to the roof support structure, such as a weather-resistant membrane and the like. A roofing overlayment is generally placed over the underlayment such as shingles, tiles, metal roofing, and the like. Often, roofing underlayments are advertised as non-slip layers, designed to prevent workers applying the layer from slipping while walking on the layer.

U.S. Pat. No. 6,308,482 entitled “Reinforced Roof Underlayment and Method of Making the Same,” issued to Strait, discloses a roofing underlayment made by an extrusion lamination process. The roofing underlayment in Strait achieves only a substrate-to-substrate static coefficient of friction, commonly referred to as “COF,” of 0.250-0.300. This range of low static COF is undesirable, whereas the efficacy of the underlayment may be detrimental when the COF is less than about 0.400. Other roofing underlayments with a COF equal to or greater than 0.400 are available. However, such underlayments are made using an adhesive lamination process and are generally not durable, whereas the adhesive may fail when exposed to wet and cold environments. Specifically, most adhesives typically break down when exposed to certain weather conditions, causing the laminated substrate layers of the underlayment to separate.

Thus, an improved roofing underlayment having an advantageous COF, utilizing a reliable extrusion lamination process, is desired.

### SUMMARY OF THE INVENTION

Embodiments of the present invention generally relate to a non-slip roofing underlayment made using an extrusion lamination process with a desirable minimum substrate-to-substrate static COF. More specifically, embodiments of the present invention relate to non-slip roofing underlayment having a COF of at least 0.400, made using an extrusion lamination process.

In one embodiment of the present invention, a method of manufacturing a roofing underlayment comprises the steps of providing a first layer of a woven thermoplastic material, extruding a second layer of thermoplastic material on the first layer, at a temperature between about 470 degrees and about 600 degrees Fahrenheit, and laminating a third layer of non-woven thermoplastic material on the second layer through a nip at a pressure between about 50 pounds per square inch and about 90 pounds per square inch.

In another embodiment of the present invention, a roofing underlayment is manufactured from the steps comprising: providing a first layer of a woven thermoplastic material, extruding a second layer of thermoplastic material on the first layer, at a temperature between about 470 degrees and about 600 degrees Fahrenheit, and laminating a third layer of non-woven thermoplastic material on the second layer through a nip at a pressure between about 50 pounds per square inch and about 90 pounds per square inch. The roofing underlayment has a substrate-to-substrate static coefficient of friction is greater than about 0.400.

### BRIEF DESCRIPTION OF THE DRAWINGS

So the manner in which the above recited features of the present invention can be understood in detail, a more particular description of embodiments of the present invention, briefly summarized above, may be had by reference to embodiments, several of which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a manufacturing system for making a non-slip roofing underlayment in accordance with one embodiment of the present invention;

FIG. 2 illustrates a section of the manufacturing system of FIG. 1, in accordance with one embodiment of the present invention;

FIG. 3 is an exploded perspective view of the layers of the non-slip roofing underlayment in accordance with one embodiment of the present invention; and

FIG. 4 illustrates a method for making a non-slip roofing underlayment in accordance with one embodiment of the present invention

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

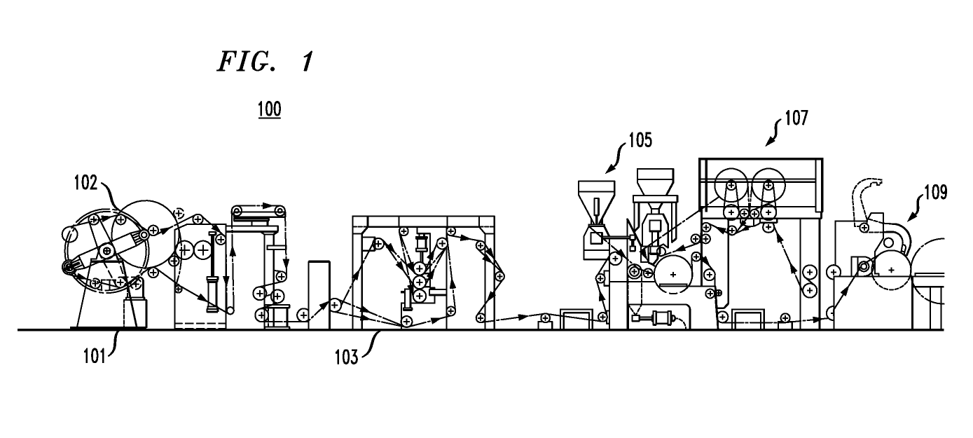

FIG. 1 depicts a system for manufacturing a roofing underlayment in accordance with one embodiment of the present invention. As shown in FIG. 1, a system 100 for making a non-slip roofing underlayment comprises an unwinding portion 101, a pre-treatment portion 103, an extrusion portion 105, a lamination portion 107, and a windup portion 109. Use of extrusion lamination facilitates the use of thermoplastic material in the underlayment to improve the tensile strength and weather-resistance of the underlayment

Several embodiments of the present invention comprise a single pass of unwinding a layer 102 of woven material, and conditioning the layer 102 for treatment using the unwinding portion 101 of the system 100. In one embodiment, the woven material may be any thermoplastic, including, but not limited to, a polyolefin, e.g., polypropylene and polyethylene, any cloth material, and the like. In another embodiment, the woven thermoplastic is a 10×10 polypropylene. Optionally, the woven layer 102 enters the pretreatment portion 103 of system 100 where a surface of the woven layer 102 is pretreated to facilitate the acceptance of melted thermoplastic to be extruded upon the woven layer surface. In one embodiment, pre-treating the surface of the woven layer 102 comprises oxidizing the surface. In another embodiment, pre-treating the surface of the woven layer 102 comprises at least one of corona treatment, plasma treatment, flame treatment, chemical priming, and the like.

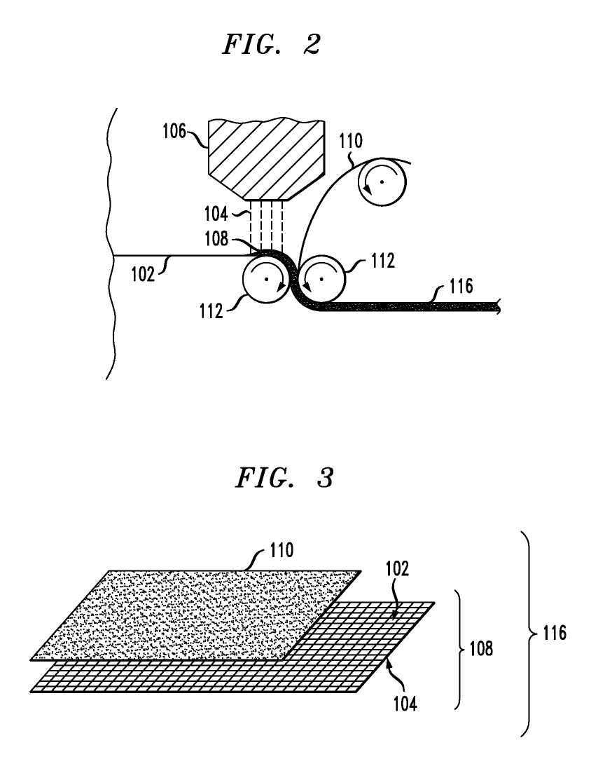

After optional pretreatment, the woven layer 102 enters the extrusion portion 105 of system 100. For further clarification, an expanded view of one embodiment of the extrusion lamination portion of system 100 is provided in FIG. 2, which is now described in conjunction with FIG. 1.

As woven layer 102 enters the extruder portion 105, a thermoplastic material 104, is heated to a melting temperature. In one embodiment, the thermoplastic material is polypropylene, which is heated between about 470 and about 600 degrees Fahrenheit. In other embodiments, materials such as polyethylene, nylon, polyester, other engineered thermoplastics, or the like, may be utilized for the extrusion process. The molten thermoplastic 104 is extruded onto the woven layer 102 using one or more extruders 106, as shown in FIG. 2, to produce a coated woven layer 108. The coated woven layer 108 then enters the lamination portion 107 of the system 100.

As coated woven layer 108 enters the lamination portion 107, a layer 110 of non-woven material is unwound and pulled into the lamination portion 107 of system 100. In one embodiment, the non-woven material comprises polypropylene. In other embodiments of the present invention, materials such as polyethylene, cotton cloth, nylon, polyurethane, or the like, may be utilized. Both the coated woven layer 108 and the non-woven layer 110 are pulled into a nip 114 between two rollers 112. In one embodiment, the nip pressure is set to a value between about 50 pounds per square inch (“psi”) and about 90 psi. The coated woven layer 108 and the non-woven layer 110 are laminated together to produce a non-slip roofing underlayment 116.

The underlayment 116 is then cured and cooled. In one embodiment, the curing process occurs as the molten resin of the underlayment 116 is cooled by a combination of chill rolls under pressure. The cooling is sufficient to bring the resin of the underlayment 116 from a molten to a rigid state with sufficient physical bonding to hold the structure in place.

The underlayment 116 then enters a winding portion 109 where it is wound into a cylindrical coil and ready for shipment. Additionally, the underlayment 116 may be tested to determine whether the associated substrate-to-substrate static COF is about 0.400. The substrate-to-substrate static COF provides an efficient method of measuring friction over other measurement methods, such as substrate-to-substrate kinetic COF and substrate-to-steel kinetic and static COFs because the substrate-to-substrate static COF fluctuates more as the parameters associated with making a non-slip roofing underlayment change, as compared to other frictional measurements.

In some embodiments, to further strengthen roofing underlayment 116, the underlayment 116 may run through one or more additional passes of system 100 and laminated to one or more additional layers of woven thermoplastic 102 in the lamination section 107. Thus, the resulting roofing underlayment may be customized with additional layers to meet various roofing needs.

FIG. 3 is an exploded perspective view of the individual layers of an underlayment 116, in accordance with one embodiment of the present invention. Specifically, at least one layer 102 of interwoven strands of polypropylene with melted polypropylene 104 extruded onto the woven layer 102, to create coated woven layer 108, is laminated to at least one layer 110 of non-woven polypropylene to produce roofing underlayment 116.

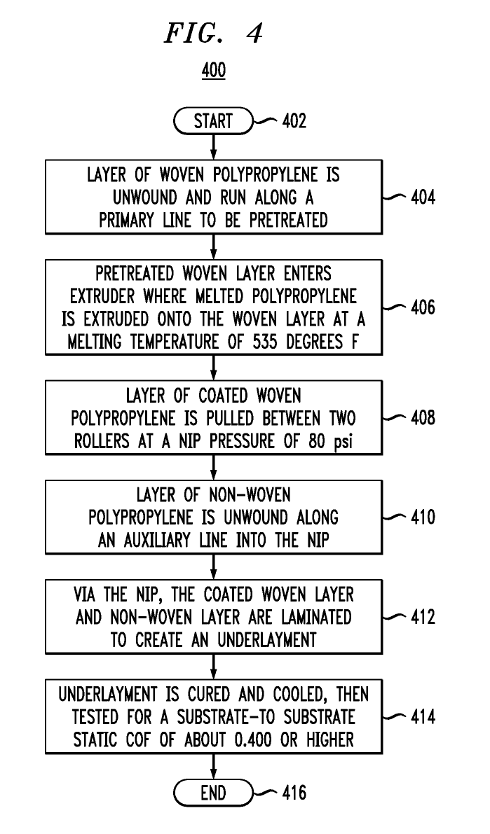

FIG. 4 illustrates steps in a process flow describing one exemplary embodiment of the present invention. The steps need not be performed in the sequence illustrated, and some of the steps may be performed substantially simultaneously. As described in FIG. 4, upon starting method 400 at step 402, a woven layer 102 of thermoplastic is unwound from a wrapped cylindrical roll and runs through a single pass on a primary process line to be pretreated, in step 404. Pretreatment of the woven layer 102 may include oxidizing a top surface of the woven layer 102 to facilitate the upcoming extrusion and lamination processes. One example of such a woven thermoplastic material is a 10×10 per square inch woven pattern of polypropylene.

Once the woven layer 102 is pretreated, in step 406, the woven layer 102 enters an extruder 106 where molten thermoplastic 104, such as molten 2 mil polypropylene, is extruded through a die onto the woven layer 102 at a melting temperature of about 535 degrees Fahrenheit, to produce a coated woven layer 108. In step 408, the coated woven layer 108 is pulled into a nip 114 of two rollers 112, wherein the pressure of the nip is set to about 80 psi.

As shown in step 410, a layer 110 of non-woven thermoplastic, such as, for example, 1 ounce spun-bonded non-woven polypropylene, is unwound and runs on an auxiliary line into the nip 114 at a time substantially simultaneous to the coated woven layer 108 entering the nip 114. In the nip, the pressure exerted upon the coated woven layer 108 and the non-woven layer 110 laminates the two layers together to create an underlayment 116, as shown in step 412.

Once laminated, the resulting underlayment 116 is cured and cooled in step 414 and is tested to determine that the substrate-to-substrate static COF is about 0.400. The underlayment 116 then is ready for use and the process ends at step 416.

Although the exemplary embodiment described in FIG. 4 depicts a single pass of one layer of woven thermoplastic 102 and one layer of non-woven thermoplastic 110 laminated together using an extruded coating 104 of melted thermoplastic to produce underlayment 116, the process in FIG. 4 may be repeated for multiple passes to further strengthen the roofing underlayment. For example, underlayment 116 may be run through an additional pass to coat the exposed woven side of the underlayment 116 with extruded melted polypropylene at 535 degrees Fahrenheit, followed by lamination to another layer of woven polypropylene at a nip pressure of 80 psi.

While the foregoing is directed to embodiments of the present invention, other and further embodiments of the invention may be devised without departing from the basic scope thereof. Specifically, embodiments of the present invention are further scalable to allow for additional clients and servers, as particular applications may require.

We claim:

1. A method of manufacturing a roofing underlayment comprising the steps:
providing a first layer of a woven material;
extruding a second layer of thermoplastic material on the first layer, at a temperature between about 470 degrees and about 600 degrees Fahrenheit; and
laminating a third layer of non-woven material on the second layer through a nip at a pressure between about 50 pounds per square inch and about 90 pounds per square inch.

2. The method of claim 1, wherein the woven material is a polyolefin.

3. The method of claim 2, wherein the woven material is polypropylene.

4. The method of claim 1, wherein non-woven material is at least one from the group of polypropylene, polyethylene, cotton cloth, nylon, and polyester.

5. The method of claim 1, wherein the extruded thermoplastic material is at least one from the group of polypropylene, nylon, polyester, and polyethylene.

6. The method of claim 1, wherein the second layer of thermoplastic material is extruded on the first layer, at a temperature between about 500 degrees and 585 degrees Fahrenheit.

7. The method of claim 6, wherein the second layer of thermoplastic material is extruded on the first layer, at about 535 degrees Fahrenheit.

8. The method of claim 1, wherein the third layer of non-woven material is laminated on the second layer through a nip at a pressure between about 60 pounds per square inch and about 85 pounds per square inch.

9. The method of claim 8, wherein the third layer of non-woven material is laminated on the second layer through a nip at about 80 pounds per square inch.

10. The method of claim 1, further comprising:
extruding an additional layer of thermoplastic material on the third layer.

11. The method of claim 10, further comprising:
laminating an additional layer of non-woven material on the additional layer of thermoplastic material.

12. A roofing underlayment manufactured from the steps comprising:
providing a first layer of a woven thermoplastic material;
extruding a second layer of thermoplastic material on the first layer, at a temperature between about 470 degrees and about 600 degrees Fahrenheit; and
laminating a third layer of non-woven thermoplastic material on the second layer through a nip at a pressure between about 50 pounds per square inch and about 90 pounds per square inch.

13. The roofing underlayment of claim 12, wherein the substrate-to-substrate static coefficient of friction is greater than about 0.400.

14. The roofing underlayment of claim 12, wherein the woven thermoplastic material is a polyolefin.

15. The roofing underlayment of claim 14, wherein the thermoplastic woven material is polypropylene.

16. The roofing underlayment of claim 12, wherein non-woven thermoplastic material is at least one from the group of polypropylene, polyethylene, nylon, and polyester.

17. The roofing underlayment of claim 12, wherein the extruded thermoplastic material is at least one from the group of polypropylene, nylon, polyester, and polyethylene.

18. The roofing underlayment of claim 12, wherein the second layer of thermoplastic material is extruded on the first layer, at a temperature between about 500 degrees and 585 degrees Fahrenheit.

19. The roofing underlayment of claim 18, wherein the second layer of thermoplastic material is extruded on the first layer, at about 535 degrees Fahrenheit.

20. The roofing underlayment of claim 12, wherein the third layer of non-woven thermoplastic material is laminated on the second layer through a nip at a pressure between about 60 pounds per square inch and about 85 pounds per square inch.

21. The roofing underlayment of claim 20, wherein the third layer of non-woven thermoplastic material is laminated on the second layer through a nip at about 80 pounds per square inch.
